(19) United States
(12) Patent Application Publication
(10) Pub. No.: US 2005/0251589 A1
(43) Pub. Date: Nov. 10, 2005

(54) Method of authenticating universal serail bus on-the-go device

(76) Inventor: Jung-Chung Wang, Kaohsiung City (TW)

Correspondence Address: J C PATENTS, INC., 4 VENTURE, SUITE 250, IRVINE, CA, 92618, US

(21) Appl. No.: 10/839,523

(22) Filed: May 4, 2004

(51) Int. Cl. G06F 13/12

(52) U.S. Cl. 710/5

(57) ABSTRACT

A method for authenticating a universal serial bus on-the-go device is provided. A first device and a second device connected via a universal serial bus supporting an on-the-go protocol are provided. The first device is a host and the second device is a peripheral device. The host uses an authentication rule to determine whether the peripheral device is an authentic device. When the peripheral device is an authentic device, the host sends an enable signal to the peripheral device to perform a host negotiation protocol so that the first device changes role to the peripheral device and the second device changes role to the host; and when the peripheral device is not the authentic device, the host declines to perform the host negotiation protocol with the peripheral device. Hence, the data security of the USB host is enhanced. The data security of the USB peripheral device can also enhanced by providing the authentication mechanism before the USB device (peripheral device) has been accessed by the other devices (e.g., the USB host) in order to prevent the unauthorized user from accessing the data in the USB peripheral device.

### BACKGROUND OF THE INVENTION

1. Field of the Invention

This invention generally relates to a method of authenticating a universal serial bus (USB) device, and more particularly to a method of authenticating a USB On-The-Go (OTG) device.

2. Description of Related Art

There are so many electronics devices we use in our daily life or in the working places. Among those electronics devices, USB is very commonly used as a data transmission interface. For example, the printer or the personal digital assistant (PDA) is connected to the computer via the USB. Among the USB devices, one of the devices acts as a host (e.g., the computer) and the other acts as a peripheral device (e.g., the printer or the PDA). The host takes charge of the USB data transmission.

Traditionally, the role the USB device acts as a host or a peripheral device is fixed. For example, the digital camera is connected to the computer via the USB to transmit/retrieve the picture (digital image files); the computer is the USB host and the digital camera is the USB peripheral device. The computer is connected to the printer via the USB to transmit the picture for printing the picture out. That is, the USB peripheral devices cannot directly communicate with each other without the USB host. Hence, the USB 2.0 specification adds the OTG supplement in order to regulate the mechanism for communication between two devices connected via USB. The detail description of the OTG supplement is shown in “On-The-Go Supplement to the USB 2.0 specification, Revision 1.0a”.

FIG. 1 shows the relationship between the Session Request Protocol (SRP) and the Host Negotiation Protocol (HNP) of the USB OTG devices. Referring to FIG. 1, the device A and device B are connected via the USB interface. The blocks 111 and 121 means that both devices A and B are at the “suspend” status. The devices A and B will be determined as a host or a peripheral device based on the SRP 130. Let's assume that the device A acts as a host (block 112) and the device B acts as a peripheral device (block 122). The device A can access the data in the device B via the USB interface. Therefore, this mechanism can overcome the traditional disadvantage that the role the USB device acts as a host or a peripheral device is fixed. Further, the devices A and B can perform role change based on the HNP 140 so that the device A becomes a peripheral device (block 113) and the device B becomes the host (block 123). Therefore, it provides a more flexible connection mechanism for USB devices. For example, the digital camera can be directly connected to the flash memory device for storing pictures or to the printer for printing the pictures without using the computer to transmit the data.

However, the OTG supplement does not provide the authentication mechanism. Since the existing USB devices usually are compact and easy to carry, the unauthorized users may illegally access or edit the data in the USB device without any difficulty.

### SUMMARY OF THE INVENTION

Accordingly, the present invention is directed to a method of authenticating the USB OTG device before the HNP is complete so that the USB host can determine whether the USB peripheral device is an authenticated device. When the USB peripheral device is not authenticated, the USB host will decline access to data. Hence the present invention can enhance the data security of the USB host.

According to an embodiment of the present invention, a method of authenticating the USB OTG device is provided. In this method, before the USB host sets up or accesses the USB peripheral device based on the OTG supplement, the USB peripheral device can determine whether the USB host is an authenticated device. When the USB host is not authenticated, the USB peripheral device will decline to perform role change. Hence the present invention can enhance the data security of the USB peripheral device.

According to an embodiment of the present invention, in the method of authenticating a universal serial bus on-the-go device, a first device and a second device are provided. The first device and the second device are connected via a universal serial bus supporting an on-the-go protocol, wherein the first device is a host and the second device is a peripheral device. The host uses an authentication rule to determine whether the peripheral device is an authenticated device. When the peripheral device is determined to be an authentic device, the host sends an enable signal to the peripheral device to perform a host negotiation protocol so that the first device changes role to the peripheral and the second device changes role to the host. On the other hand, when the peripheral device is not determined not to be an authentic device, the host declines to perform the host negotiation protocol with the peripheral.

In an embodiment of the present invention, the first device as the host and the second device as the peripheral device are determined according to a session request protocol.

In an embodiment of the present invention, the authentication rule is a share key authentication.

In an embodiment of the present invention, the authentication rule to determine whether the peripheral device is an authentic device is provided. The host sends a plain text to the peripheral device. Next, the peripheral device ciphers the plain text based on a share key to obtain a corresponding cipher text. Next, the peripheral device sends the cipher text to the host. Next, the host determines whether the cipher text is correct according to the share key and the plain text, wherein when the cipher text is correct, the peripheral device determined to be an authentic device; otherwise, the peripheral device is determined as not being the authentic device.

In an embodiment of the present invention, when the host does not obtain the cipher text in a predetermined time after the host sends the plain text to the peripheral device, the host declines to perform the host negotiation protocol with the peripheral device.

In an embodiment of the present invention, the peripheral device sends a peripheral device data to the host; and the host determines whether the peripheral device supports the authentication rule based on the peripheral device data, if the peripheral device does not support the authentication rule, the host declines to perform the host negotiation protocol with the peripheral device.

In an embodiment of the present invention, the peripheral device data includes a peripheral device identification information. The host sets up a device authentication information table. The device authentication information table records the peripheral device identification information and a number of failed authentication corresponding to the peripheral device identification information; wherein when the host determines the cipher text is not correct, the peripheral device identification information corresponding to the peripheral device is stored in the device authentication information table and one is added to the number of failed authentication; and the host checks the number of failed authentication, when the number of failed authentication is larger than a predetermined number (e.g., three), the host declines to perform the host negotiation protocol with the peripheral device.

In an embodiment of the present invention, when the host determines the cipher text is correct, the number of failed authentication is reset to be zero.

The present invention is directed to a method of authenticating a universal serial bus on-the-go device. A first device and a second device are provided. Next, the first device and the second device are connected via a universal serial bus supporting an on-the-go protocol, wherein the first device is a host and the second device is a peripheral device. The peripheral device uses an authentication rule to determine whether the host is an authentic device; wherein when the host is determined to be the authentic device, the peripheral device allows the host to access data in the peripheral device; and when the host is determined to be not the authentic device, the peripheral device declines the host to access the data in the peripheral device.

In an embodiment of the present invention, the host uses an authentication rule to determine whether the peripheral device is an authentic device. The peripheral device sends a plain text to the host. Next, the host ciphers the plain text based on a share key to obtain a corresponding cipher text. Next, the host sends the cipher text to the peripheral device. Next, the peripheral device determines whether the cipher text is correct according to the share key and the plain text, wherein when the cipher text is correct, the host is determined to be the authentic device, and when the cipher text is not correct, the host is determined to be not the authentic device.

In an embodiment of the present invention, the peripheral device sends a peripheral device data to the host; and the host determines whether the peripheral device supports/enables the authentication rule based on the peripheral device data, wherein when the peripheral device does not support/enable the authentication rule, the host is allowed to access the data in the peripheral device.

In the present invention, because the authentication mechanism is added into the OTG supplement, it can prevent the data in the USB device from being illegally accessed and thus can enhance the data security. The present invention can protect the data in the USB host from the unauthorized users accessing the data by using the OTG supplement to change the role of the USB host to the USB peripheral device. The present invention can also protect the data in the USB peripheral device by providing the authentication mechanism before the USB device (peripheral device) has been accessed by the other devices (e.g., the USB host) in order to prevent the unauthorized user from accessing the data in the USB peripheral device.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF THE DRAWINGS

FIG. 1 illustrates a relationship between the Session Request Protocol (SRP) and the Host Negotiation Protocol (HNP) of the USB OTG devices.

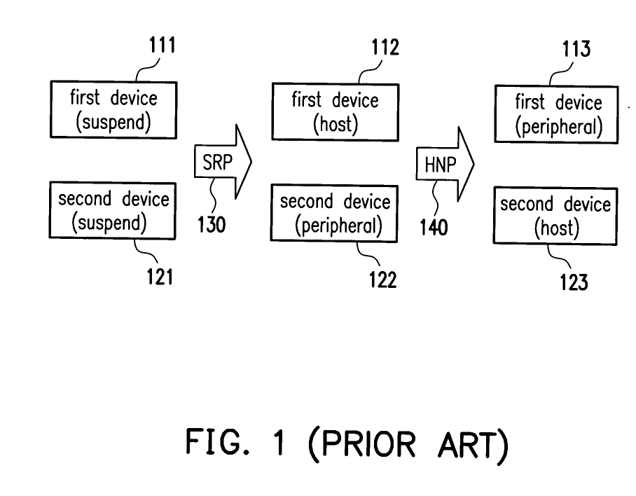

FIG. 2 shows the flow chart of a USB OTG device authentication before performing the role change in accordance with an embodiment of the present invention.

FIG. 3 shows the flow chart at the time that the USB host waits for the cipher text form the USB peripheral device in accordance with an embodiment of the present invention.

FIG. 4 shows the flow chart of a method of authenticating a USB OTG device in accordance with another embodiment of the present invention.

### DESCRIPTION OF THE EMBODIMENTS

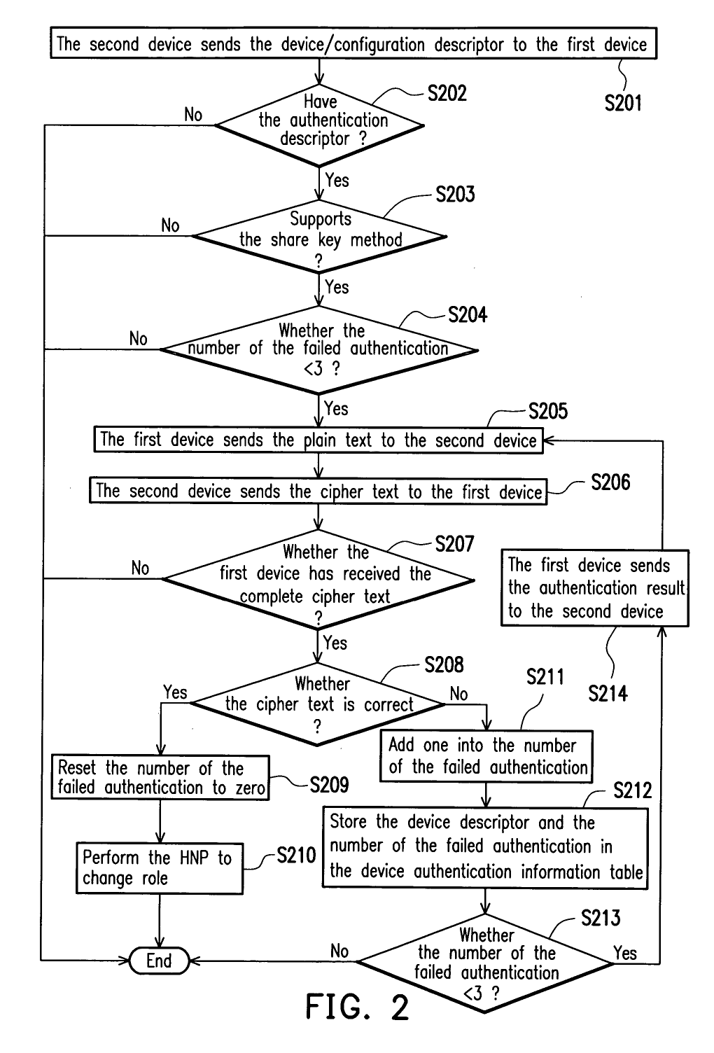

FIG. 2 shows a flow chart of a USB OTG device authentication before performing the role change in accordance with an embodiment of the present invention. Referring to FIG. 2, here we assume that the first and the second devices have been provided (not shown) and the first and second devices are connected via the USB supporting the OTG protocol, and that the first device is the host and the second device is the peripheral device. The second device sends the peripheral device information to the first device according to the data structure of the OTG protocol (S201). The peripheral device information includes such as device descriptor, the configuration descriptor and the authentication descriptor. Regarding the device descriptor, the configuration descriptor, refer to the “On-The-Go Supplement to the USB 2.0 specification, Revision 1.0a”.

The first device then determines whether the peripheral device information from the second device includes the authentication descriptor (S202). That is, in S202 the first device will check whether the second device support the authentication procedure; if not, the first device in this embodiment will decline to perform the host negotiation protocol (HNP) with the second device; i.e., the first device will decline to perform the role change with the second device.

The above authentication descriptor in this embodiment can be the data structure shown in Table 1. In this embodiment, the first byte of the authentication descriptor represents the length of the authentication descriptor uses (here, it is 4 bytes); the second byte of the authentication descriptor represents the type of the descriptor (here, “0x41” means that the descriptor is an authentication descriptor); the third byte of the authentication descriptor represents the authentication type (algorithm) it supports (here, the share key authentication is used as an example). Hence, for example, if the type of the descriptor is “0”, then it means it does not support the share key authentication; if the type of the descriptor is “1”, then it means it supports the share key authentication. The fourth byte of the authentication descriptor represents the authentication status as “enable” (e.g., “1”) or “disable” (e.g., “0”).

TABLE 1
The data structure of the authentication descriptor in
accordance with an embodiment of the present invention.

| Byte | Content | Description |
|---|---|---|
| 1 | length | 4 |
| 2 | descriptor type | 0 × 1 |
| 3 | authentication type | 0: not support |
| | | 1: support share key authentication |
| 4 | Authentication status | 0: disable |
| | | 1: enable |

When the peripheral device information includes the authentication descriptor, then it would further determine whether the second device supports the predetermined authentication rule (S203). In this embodiment the share key authentication is used. If not, the first device will decline to perform the HNP with the second device. Otherwise, if the second device supports the predetermined authentication rule, then the step S204 will be performed.

To prevent an unauthorized user from changing the role of the first device from the host to the peripheral device via OTG protocol in order to illegally access the data in the first device, the first device in this embodiment has a device authentication information table. This device authentication information table will record the information of all device having tried to change role and the number of the failed authentication. The data structure of the device authentication information table is shown in FIG. 2. The 0^{th} to 19^{th} bytes records one the devices having tried to change role. The 20^{th} to 39^{th} bytes record another one the devices having tried to change role. The 40^{th}-59^{th} bytes and the following bytes can be obtained by analogy. Taking the 0^{th} to 19^{th} bytes as an example, the 0^{th} byte records the data status of the 0^{th} to 19^{th} bytes; e.g., when the 0^{th} byte is “0”, it means the status is “disable”; when the 0^{th} byte is “1”, it means the status is “enable”. The 1^{st} to 18^{th} bytes record the device information of the device having tried to be authenticated. Because the device information is unique, it can recognize the device having tried to be authenticated (e.g., it can indicate the above second device). The 19^{th} byte records the number of the failed authentication of that device (e.g., the second device).

TABLE 2
The data structure of the device authentication information
table in accordance with an embodiment of the present invention.

| Byte | Content | Description |
|---|---|---|
| 0 | Data enabled A | 0: Disable |
| | | 1: Enable |
| 1-18 | Device Descriptor A | Device Descriptor Info |
| 19 | Failed authentication | When the number is larger than 3, this |
| | counter A | device will be declined to authenticate |
| 20 | Data enabled B | 0: Disable |
| | | 1: Enable |
| 21-38 | Device Descriptor B | Device Descriptor Info |
| 39 | Failed authentication | When the number is larger than 3, this |
| | counter B | device will be declined to authenticate |
| . . . | . . . | . . . |

The first device (host) searches the number of the failed authentication based on the device descriptor from the second device (peripheral device) (S204); if the number is larger than 3, the first device will decline to perform HNP with the second device. Otherwise, the step S205 will be performed.

The first device (host) will send the plain text to the second device (peripheral device) (S205). The content of the plain text can be any content or generated by the random number. But the first device must keep this plain text for subsequent use. The data structure of the plaintext descriptor is shown in Table 3. The 0^{th} byte means the length of the plaintext descriptor (e.g., here it is X+3 bytes; X is a positive integer). The 1^{st} byte records the type of the descriptor (e.g., here “0x42” represents the plaintext descriptor). The 2^{nd} byte records the share key number. The 3^{rd} to X+2^{nd} bytes record the content of the plain text.

TABLE 3
The data structure of the plaintext descriptor in accordance
with an embodiment of the present invention.

| Byte | Content | Description |
|---|---|---|
| 0 | length | X + 3 |
| 1 | descriptor type | 0 × 42 |
| 2 | Status | Share key number |
| 3 − (X + 2) | Plain text | Content of the plain text (X bytes) |

The second device (peripheral device) receives the plaintext descriptor, selects the predetermined share key based on the share key number to cipher the plain text, and obtains the cipher text. The second device then sends the cipher text to the first device (S206). The data structure of the ciphertext descriptor is shown in Table 4. The 0^{th} byte means the length of the ciphertext descriptor (e.g., here it is X+3 bytes; X is a positive integral). The 1^{st} byte records the type of the descriptor (e.g., here “0x43” represents the ciphertext descriptor). The 2^{nd} byte records the cipher status of the second device (e.g., “0” means no cipher text; “1” means the cipher process is not complete (NAK); “2” means the cipher process is complete (OK)). The 3^{rd} to X+2^{nd} bytes record the content of the cipher text.

TABLE 4
The data structure of the ciphertext descriptor in accordance
with an embodiment of the present invention.

| Byte | Content | Description |
|---|---|---|
| 0 | length | X + 3 |
| 1 | descriptor type | 0 × 43 |
| 2 | Status | 0 - No cipher text |
| | | 1 - NAK |
| | | 2 - OK |
| 3 − (X + 2) | Cipher text | Content of the cipher text (X bytes) |

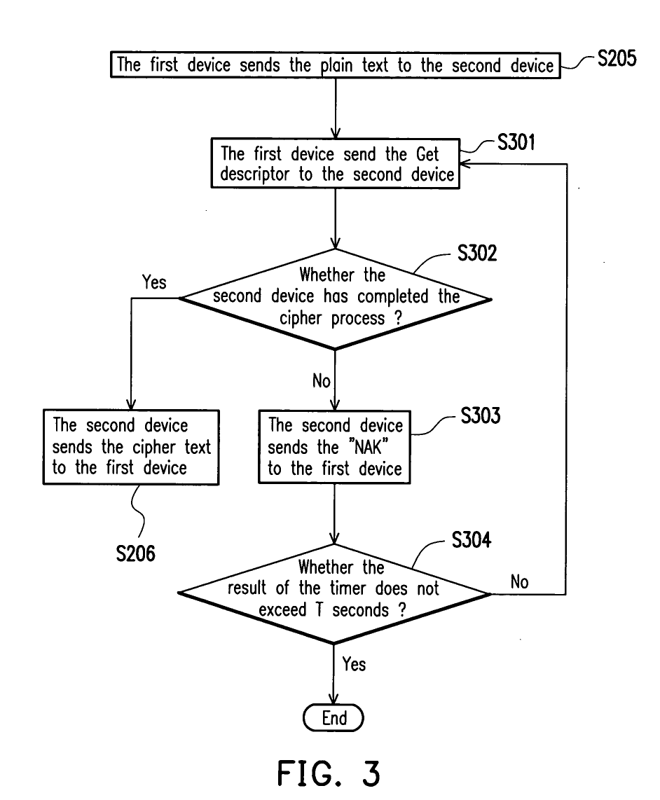

To prevent the cipher process from taking too long, the time-limit mechanism can be added into between the steps S205 and S206. FIG. 3 shows the flow chart at the time that the USB host waits for the cipher text form the USB peripheral device in accordance with an embodiment of the present invention. Referring to FIGS. 2 and 3, the first device (host) sends the plain text to the second device (peripheral device) and the second device ciphers the plain text (S205). At the same time, the timer in the first device starts to count time. The first device can send the GetDescriptor to the second device at any time during the period the first device and wait for the cipher text to ask the status of the cipher process (S301). If the second device has completed the cipher process (S302), then the step S206 will be performed. If the second device has not completed the cipher process, it will send the “NAK” information to the first device (S303). When the first device receives the “NAK” information, if the result of the timer does not exceed the predetermined time (e.g., T seconds; T is a positive integral)(S304), the step S301 will be repeated. If the result of the timer does exceed the predetermined time, the first device will decline to perform the HNP with the second device.

Referring to FIG. 2, in step S207, the first device (host) will check whether it has received the cipher text. If the first device cannot completely receive the cipher text, the first device will decline to perform the HNP with the second device. If the first device has completely received the cipher text, it will use the predetermined share key and the plain text to check whether the cipher text is correct (S208). If it is correct, the first device will reset the number of the failed authentication in the device authentication information table to zero (S209) and performs the HNP with the second device (S210). After performing the HNP, the first device will change role from the host to the peripheral device, and the second device will change role from the peripheral device to the host. Regarding the HNP, please refer to the “On-The-Go Supplement to the USB 2.0 specification, Revision 1.0a”.

If the result is not correct in step S208, the first device will add one to the number of the failed authentication (S211) and stores the device descriptor information and the number of the failed authentication in the device authentication information table (S212). The first device will check whether the number of the failed authentication exceeds the predetermined number (here the predetermined number is three) (S213). If the number of the failed authentication exceeds the predetermined number, the first device will decline to perform the HNP with the second device. If not, the first device will send the authentication result to the second device (S214). The data structure of the authentication-result descriptor is shown in Table 5. The 0^{th} byte means the length of the authentication-result (e.g., here it is 3 bytes). The 1^{st} byte shows the current authentication result (e.g., “0” means it is failed and “1” means it is authenticated). The 2^{nd} byte records the number of the failed authentication.

TABLE 5
The data structure of the authentication-result descriptor in
accordance with a preferred embodiment of the present invention.

| Byte | Content | Description |
|---|---|---|
| 0 | length | 3 |
| 1 | Current authentication result | 0 - Fail |
| | | 1 - OK |
| 2 | Authentication Fail Counter | the number of the failed |
| | | authentication |

The above embodiment is to protect the data security in the USB host from unauthorized access so that the unauthorized user cannot use USB OTG protocol to change role of the USB host to the USB peripheral device. But if the device to be protected is the USB peripheral device, the above embodiment cannot apply. To apply this present invention in this situation, the present invention provides another method for authenticating the USB OTG device. When the device to be protected is the USB peripheral device, the authentication mechanism is provided before the USB device (peripheral device) has been accessed by the other devices (e.g., the USB host) in order to prevent the unauthorized user from accessing the data in the USB peripheral device. Hence, another embodiment of the present invention will be illustrated as follows to further describe the present invention.

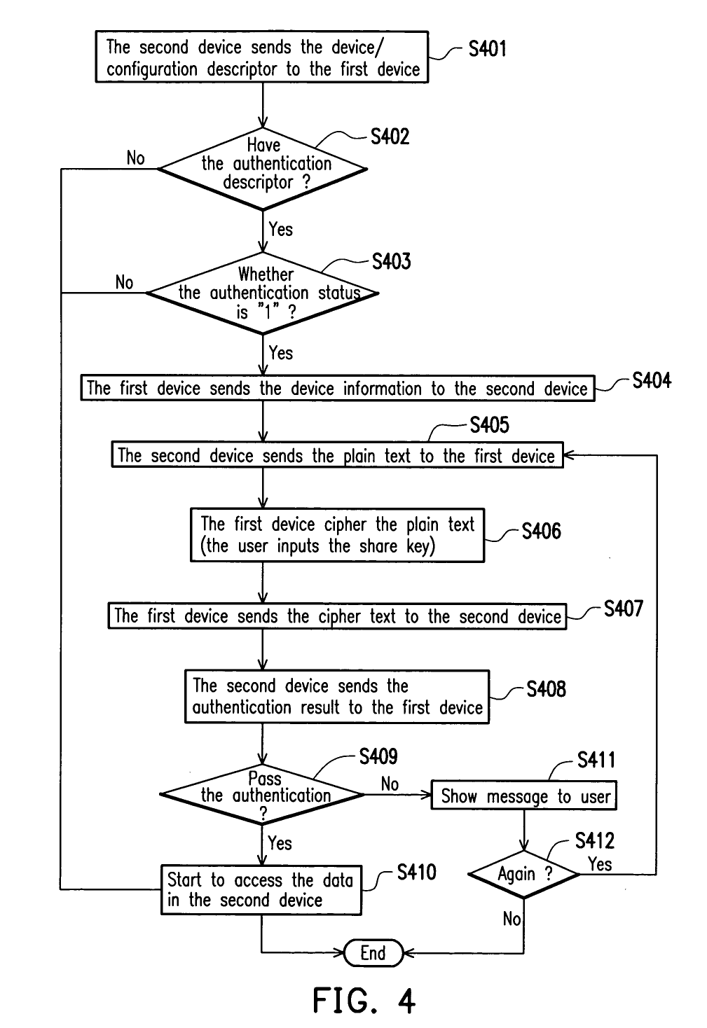

FIG. 4 shows the flow chart of a method of authenticating a USB OTG device in accordance with another embodiment of the present invention. Referring to FIG. 4, here we assume that the first and second devices have been provided (not shown) and the first and second devices are connected via the USB supporting the OTG protocol, and that the first device is the host and the second device is the peripheral device. The second device sends the peripheral device information to the first device according to the data structure of the OTG protocol (S401). The peripheral device information includes such as device descriptor, the configuration descriptor and the authentication descriptor. Regarding the device descriptor, the configuration descriptor, refer to the “On-The-Go Supplement to the USB 2.0 specification, Revision 1.0a”.

The first device then determines whether the peripheral device information from the second device includes the authentication descriptor (S402). That is, in S402 the first device will check whether the second device supports the authentication procedure; if not, the first device in this embodiment will access the data in the second device like the other USB OTG device. Otherwise, if the second device supports the authentication procedure, then the step S403 is performed. The authentication descriptor in this embodiment is the same as that in the previous embodiment shown in Table 1 and hence will not be repeated here.

In step S403, the first device will determine whether the authentication status of the second device is “enable” (in this embodiment, “1” means “enable” and “0” means “disable”). If the status is “1”, then the step S404 will be performed; if the status is “0”, then the first device will access the data in the second device like the other USB OTG device.

In step S404, the first device (host) sends the device information to the second device (peripheral device). The second device will send the plain text to the first device after receiving the device information from the first device (S405). The content of the plain text can be any content or generated by the random number. But the second device must keep this plain text for subsequent use. The data structure of the plaintext descriptor is shown in Table 3 and will not be repeated here.

The first device will cipher the plain text after receiving the plaintext descriptor (S406). The share key in this embodiment can be inputted by the user. When the first device ciphers the plain text, and obtains the cipher text, it sends the cipher text to the second device (peripheral device)(S407). After the second device receives the complete cipher text, it will use the predetermined share key and the plain text to check the cipher text is correct or not and will send the authentication result to the first device (S408).

The first device then determines whether it has passed the authentication based on the authentication result (S409). If it has passed, the first device is allowed to access the data in the second device (S410). Otherwise, the first device will show the information to let the user know the authentication failed (S411) and will ask the user whether he wants to input the share key for another authentication (S412). If yes, then the steps S405-S412 will be repeated again; otherwise, the authentication procedure is ended; i.e., the second device declines to be accessed by the first device via the USB.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A method of authenticating a universal serial bus on-the-go device, comprising:
providing a first device and a second device, said first device and said second device being connected via a universal serial bus supporting an on-the-go protocol, said first device being a host and said second device being a peripheral device;
said host using an authentication rule to determine whether said peripheral device is an authentic device;
wherein when said peripheral device is said authentic device, said host sends an enable signal to said peripheral device to perform a host negotiation protocol so that said first device changes role to said peripheral device and said second device changes role to said host; and
when said peripheral device is not said authentic device, said host declines to perform said host negotiation protocol with said peripheral device.

2. The method of claim 1, wherein said step of providing said first device and said second device includes determining said first device as said host and said second device as said peripheral device according to a session request protocol.

3. The method of claim 1, wherein said authentication rule is a share key authentication.

4. The method of claim 1, wherein said step of said host using an authentication rule to determine whether said peripheral device is an authenticated device includes:
said host sending a plain text to said peripheral device;
said peripheral device ciphering said plain text based on a share key to obtain a corresponding cipher text;
said peripheral device sending said cipher text to said host; and
said host determining whether said cipher text is correct according to said share key and said plain text,
wherein when said cipher text is correct, said peripheral device is an authentic device;
wherein when said cipher text is not correct, said peripheral device is not an authentic device.

5. The method of claim 4, further comprising when said host does not obtain said cipher text in a predetermined time after said host sends said plain text to said peripheral device, said host declining to perform said host negotiation protocol with said peripheral device.

6. The method of claim 4, further comprising
said peripheral device sending a peripheral device data to said host; and
said host determining whether said peripheral device supports said authentication rule based on said peripheral device data, wherein when said peripheral device does not support said authentication rule, said host declines to perform said host negotiation protocol with said peripheral device.

7. The method of claim 4, wherein said peripheral device data includes a peripheral device identification information, said method further comprising
said host setting up a device authentication information table, said device authentication information table recording said peripheral device identification information and a number of failed authentication corresponding to said peripheral device identification information;
wherein when said host determines said cipher text is not correct, said peripheral device identification information corresponding to said peripheral device is stored in said device authentication information table and one is added to said number of failed authentication; and
said host checking said number of failed authentication, wherein when said number of failed authentication is larger than a predetermined number, said host declines to perform said host negotiation protocol with said peripheral device.

8. The method of claim 7, wherein said predetermined number is three.

9. The method of claim 7, further comprising when said host determines said cipher text is correct, resetting said number of failed authentication to be zero.

10. A method of authenticating a universal serial bus on-the-go device, comprising:
providing a first device and a second device, said first device and said second device being connected via a universal serial bus supporting an on-the-go protocol, said first device being a host and said second device being a peripheral device;
said peripheral device using an authentication rule to determine whether said host is an authenticated device;
wherein when said host is an authentic device, said peripheral device allows said host to access data in said peripheral device; and
wherein when said host is not an authentic device, said peripheral device declines said host to access said data in said peripheral device.

11. The method of claim 10, wherein said step of providing said first device and said second device includes determining said first device as said host and said second device as said peripheral device according to a session request protocol.

12. The method of claim 10, wherein said authentication rule is a share key authentication.

13. The method of claim 10, wherein said step of said host using an authentication rule to determine whether said peripheral device is an authentic device includes
said peripheral device sending a plain text to said host;
said host ciphering said plain text based on a share key to obtain a corresponding cipher text;
said host sending said cipher text to said peripheral device; and
said peripheral device determining whether said cipher text is correct according to said share key and said plain text,
wherein when said cipher text is correct, said host is determined as an authentic device;
and wherein when said cipher text is not correct, said host is determined as not an authentic device.

14. The method of claim 13, further comprising
said peripheral device sending a peripheral device data to said host; and
said host determining whether said peripheral device supports/enables said authentication rule based on said peripheral device data, wherein when said peripheral device does not support/enable said authentication rule, said host is allowed to access said data in said peripheral device.
